(19) United States
(12) Patent Application Publication
(10) Pub. No.: US 2022/0381391 A1
(43) Pub. Date: Dec. 1, 2022

(54) INTERLOCKING OUTRIGGER PAD SUPPORT SYSTEM

(71) Applicant: DICA MARKETING COMPANY, Guthrie Center, IA (US)

(72) Inventors: Kris Koberg, Cedar Rapids, IA (US); Dan Lewis, West Des Moines, IA (US)

(21) Appl. No.: 17/825,636

(22) Filed: May 26, 2022

Related U.S. Application Data
(60) Provisional application No. 63/193,624, filed on May 27, 2021.

(51) Int. Cl. F16M 3/00

(52) U.S. Cl. CPC F16M 3/00; F16M 2200/08

(57) ABSTRACT

An interconnected outrigger pad support system is provided. The system includes a base pad assembly layer, a support layer, and an upper pad. The base pad assembly layer is formed of a plurality of base pads having alignment features that extend across at least a portion of the upper surface of the plurality of base pads. The support layer is placed on top of the base pad assembly layer and the support layer engages and is held in place by the alignment features of the plurality of base pads. In one or more arrangements, the upper pad has an upper surface and a lower surface, with the lower surface also having an alignment feature. When the upper pad is placed on top of the support layer, the alignment feature of the upper pad engages and is held in place by the support layer.

### CROSS-REFERENCE TO RELATED APPLICATIONS

The present application claims priority to U.S. Provisional Application 63/193,624, titled INTERLOCKING OUTRIGGER PAD SUPPORT SYSTEM, and filed on May 27, 2021, the entirety of which is hereby incorporated by reference herein, including any figures, tables or drawings or other information.

### FIELD OF THE DISCLOSURE

This disclosure relates to pads for supporting outrigger arms of cranes, trucks, and other vehicles and equipment. More specifically and without limitation, this disclosure relates to a pad support system formed of a plurality of interlocking components.

### BACKGROUND OF THE DISCLOSURE

Outriggers are old and well known in the art and are frequently used to provide additional stability and support to cranes, boom trucks, aerial work platforms, concrete pump trucks and the like. There are countless types, forms and designs of outriggers known in the art. Generally speaking, these outriggers extend outward from the body of the vehicle or equipment and engage the ground thereby giving a greater base of stability which increases safety and allows the vehicle or equipment to move heavier loads or increase its reach with greater security and safety.

Pads, mats, blocking or cribbing are sometimes used to provide a foundation for outriggers, stabilizers, jacks or similar devices and the outriggers may rest on the pad, mat, blocking or cribbing. Since the outriggers are typically used to provide a greater base of stability which allows the equipment to move heavier loads and increase its reach, the pads must be able to withstand a great deal of force and do this without moving or slipping, thereby jeopardizing the stability of the outrigger and the safety of the operator and other individuals and property in the area surrounding the outrigger. Pads, mats, blocking and cribbing must be able to effectively distribute the exerted load and pressures from the outriggers to the supporting ground under the pads, mats, blocking and cribbing. Distribution of load can be measured by the reduction of pressure being exerted onto the ground and the utilization of the pads, mats, cribbing or blocking. Many devices and assemblies currently used as pads, mats, cribbing and blocking do not effectively distribute load over a large area. The result is a decrease in safety, and increased potential to damage the ground and even ground failure causing equipment to overturn. While some large pads, mats, blocking and cribbing may distribute the load over a wide area, such large devices are not practical to transport, store, deploy, remove or adjust.

Pads, mats, blocking and cribbing must be able to protect the supporting surface from damage that can be caused by outriggers. Pressures exerted by outriggers can exceed the capacity of the supporting surface thereby causing the supporting surface to shear, crack, crumble or fail. Most outriggers are constructed from iron, steel, aluminum, or other metallic materials. Both metallic and non-metallic materials can scar, imbed, scratch, crack or otherwise damage supporting surfaces. Pads, mats, cribbing & blocking in combination with other material when needed should help prevent damage to supporting surfaces that outriggers can cause.

Further complicating protection of the supporting surface is the fact that outrigger feet from equipment can be small. This, combined with the potential outrigger loads, can create a high pressure or point loaded moment. The highly concentrated point load makes it difficult for traditional pads, mats, and cribbing to effectively distribute the pressure over the required area to ensure the pressure exerted onto the ground does not exceed the ground's ability to support the pressure. Additionally, the high concentration of pressure can cause traditional materials such as wood to fail abruptly from compression and sheer.

A number of different materials have been used to create these pads, mats, blocking and cribbing. One such materials is wood. While wood is cheap and reasonably lightweight, making it easy to move, wood is relatively weak and cannot withstand some of the loads under which it may be placed when in use. Additionally, wood is less durable and more susceptible to wear and tear, which means wooden pads would need to be replaced frequently. In addition, pads formed of wood are susceptible to breaking, which can have catastrophic effects.

Another material used to make pads or mats are composite materials. Composite materials are lightweight, thereby making them easy to move and transport. Composite materials can be designed to various levels of strength, however, some are not as strong as certain other materials and may not be able to support some of the heaviest loads they may be placed under when in use. Additionally, some composite materials are less rigid and more susceptible to displacement from bending when placed under large loads, which reduces the stability of the outrigger and the safety of the operator and other individuals and property in the area.

Another material which has been used to make pads or mats are metallic materials. Certain metallic materials, such as iron or steel, are very strong and may be able to withstand heavy loads that may be placed on the pads when in use. Strong metallic materials, like iron or steel are rigid and less likely to experience displacement when placed under such heavy loads. However, metallic materials such as iron or steel are extremely heavy, thereby making them difficult to produce, difficult to move and use in the field and more difficult and expensive to transport.

Therefore, for all the reasons stated above, and the reasons stated below, there is a need in the art for an improved outrigger pad support system which has the necessary strength, rigidity, and durability to distribute loads over a larger area, while also remaining easy to transport and store.

Thus, it is a primary object of the disclosure to provide an outrigger pad support system that improves upon the state of the art.

Another object of the disclosure is to provide an outrigger pad support system that is formed of interlocking components.

Yet another object of the disclosure is to provide an outrigger pad support system that is convenient to transport.

Another object of the disclosure is to provide an outrigger pad support system that is convenient to transport and store.

Yet another object of the disclosure is to provide an outrigger pad support system that may be deployed by hand (without the use of a crane).

Yet another object of the disclosure is to provide an outrigger pad support system that may be assembled out of a plurality of components thereby forming a system that has a greater overall carrying capacity than the carrying capacity of each component of the system.

Another object of the disclosure is to provide an outrigger pad support system that can effectively distribute load over a larger area.

Yet another object of the disclosure is to provide an outrigger pad support system that is rigid.

Another object of the disclosure is to provide an outrigger pad support system that minimizes displacement under heavy loads.

Yet another object of the disclosure is to provide an outrigger pad support system that is relatively easy to manufacture.

Another object of the disclosure is to provide an outrigger pad support system that is easy to use.

Yet another object of the disclosure is to provide an outrigger pad support system that is relatively lightweight.

Another object of the disclosure is to provide an outrigger pad support system that is easy to move.

Yet another object of the disclosure is to provide an outrigger pad support system that has a robust design.

Another object of the disclosure is to provide an outrigger pad support system that is durable.

Yet another object of the disclosure is to provide an outrigger pad support system that has a long useful life.

Another object of the disclosure is to provide an outrigger pad support system that is not easily susceptible to wear and tear.

Yet another object of the disclosure is to provide an outrigger pad support system that is high quality.

Another object of the disclosure is to provide an outrigger pad support system that is relatively inexpensive.

Yet another object of the disclosure is to provide an outrigger pad support system that increases safety for the operator and other individuals and property in the area.

Another object of the disclosure is to provide an outrigger pad support system that is easy to transport.

Another object of the disclosure is to provide an outrigger pad support system that effectively distributes loads & pressures from outriggers to levels the supporting surface can withstand, or levels deemed acceptable by site owners.

Another object of the disclosure is to provide an outrigger pad support system that protects supporting surfaces from damage caused by outriggers.

Another object of the disclosure is to provide an outrigger pad support system that has the strength to withstand heavy loads.

These and other objects, features, or advantages of the disclosure will become apparent from the specification, figures, and claims.

### SUMMARY OF THE DISCLOSURE

In one or more arrangements, an interconnected outrigger pad support system is provided. The system includes a base pad assembly layer, a support layer, and an upper pad. In one or more arrangements, the base pad assembly layer is formed of a plurality of base pads. In one or more arrangements, each of the plurality of base pads have an upper surface and a lower surface. In one or more arrangements, the base pads of the base pad assembly layer have alignment features that extend across at least a portion of the upper surfaces of the plurality of base pads. Wherein when the middle support layer is placed on top of the base pad assembly layer, the middle support layer engages and is held in place by the alignment features of the base pads of the base pad assembly layer. In one or more arrangements, the upper pad has an upper surface and a lower surface. The lower surface of the upper pad also has an alignment feature. When the upper pad is placed on top of the support layer, the alignment feature of the upper pad engages and is held in place by the support layer.

### BRIEF DESCRIPTION OF THE FIGURES

FIG. 1 is a perspective view of the interlocking outrigger pad support system showing a base pad assembly layer formed of a plurality of base pads, a support layer formed of interconnected support members in engagement with the base pads, and an upper pad in engagement with the support members.

FIG. 2 is an exploded view of the interlocking outrigger pad support system showing a base pad assembly layer formed of a plurality of base pads with alignment features comprised of recesses therein; a support layer formed of a plurality of support members exploded from each other, with two support members having upward facing notches configured to interconnect with downward facing notches on the remaining support members; and an upper pad.

FIG. 3 is an exploded view of the interlocking outrigger pad support system showing a base pad assembly layer formed of a plurality of base pads with alignment features comprised of recesses therein; a support layer formed of a plurality of interconnected support members; and an upper pad.

FIG. 4 is an exploded view of the interlocking outrigger pad support system showing a base pad assembly layer formed of a plurality of base pads; a support layer formed of a plurality of interconnected support members; and an upper pad.

FIG. 5 is an exploded view of the interlocking outrigger pad support system showing a base pad assembly layer formed of a plurality of base pads with alignment features comprised of recesses therein, and a support layer formed of a plurality of interconnected support members with an upper pad in engagement with the support members.

FIG. 6 is perspective view of the interlocking outrigger pad support system showing a base pad assembly layer formed of a plurality of base pads, with a support layer formed of interconnected support members in engagement with the base pads, and an upper pad in engagement with the support members.

FIG. 7 is an exploded view showing the support layer made of interconnected support members and an upper pad with a protrusion forming an alignment feature on the bottom of the upper pad.

FIG. 8 is a perspective view of an upper pad, the view showing the upper pad having an upper surface, a lower surface, a front edge, a back edge, a right edge, a left edge, a recess configured to receive and hold outriggers or feet of machinery, and a handle.

FIG. 9A is an elevation view of the upper pad, the view showing the upper surface of the upper pad.

FIG. 9B is a plan view of the upper pad, the view showing an edge of the upper pad.

FIG. 10A is an elevation view of the interlocking outrigger pad support system, the view showing a base pad assembly layer formed of a plurality of base pads, a support layer formed of a plurality of interconnected support members, and an upper pad.

FIG. 10B is a plan view of the interlocking outrigger pad support system, the view showing a base pad assembly layer, a support layer resting on top of the base pad assembly layer, and an upper pad resting on top of the support layer.

FIG. 11A is an exploded view of the interlocking outrigger pad support system, the view showing a base pad assembly layer formed of a plurality of base pads, the plurality of base pads having varying depths of recesses on the top surface of the plurality of base pads; the view also showing a support layer formed of a plurality of support members, with two of the support members having notches and two of the support members having no notches.

FIG. 11B is an exploded plan view of the support layer, the view showing a support members having notches extending in perpendicular alignment with two other support members.

FIG. 11C is an exploded plan view of the support layer, the view showing a support member extending in a perpendicular manner to two other support members.

FIG. 12A is an exploded view of the interlocking outrigger pad support system, the view showing a base pad assembly layer formed of a plurality of base pads; the view also showing two support members having deep notches and two support members having shallow notches configured to interlock with the deep notches on the other two support members.

FIG. 12B is an exploded plan view of the support layer, the view showing a support member having shallow notches extending in perpendicular alignment with two other support members.

FIG. 12C is an exploded plan view of the support layer, the view showing a support member having deep notches extending in perpendicular alignment with two other support members.

FIG. 13 is a top view of the base pad assembly layer formed of a plurality of base pads, the view showing the base pads having an alternative configuration of alignment features made up of recesses which do not overlap.

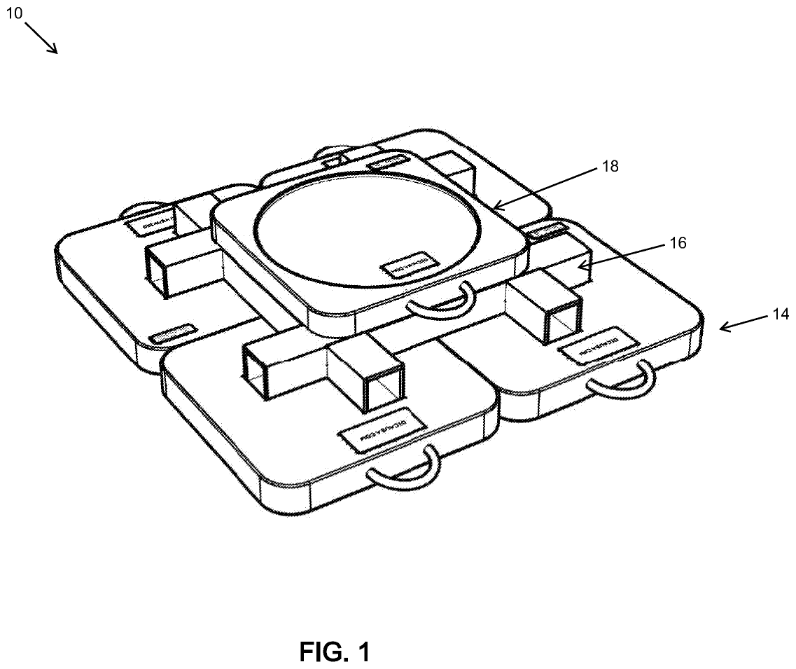

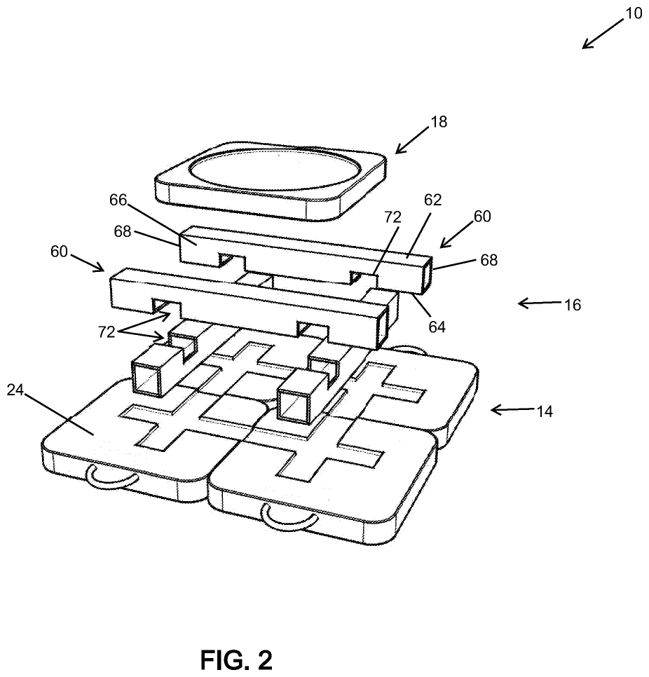

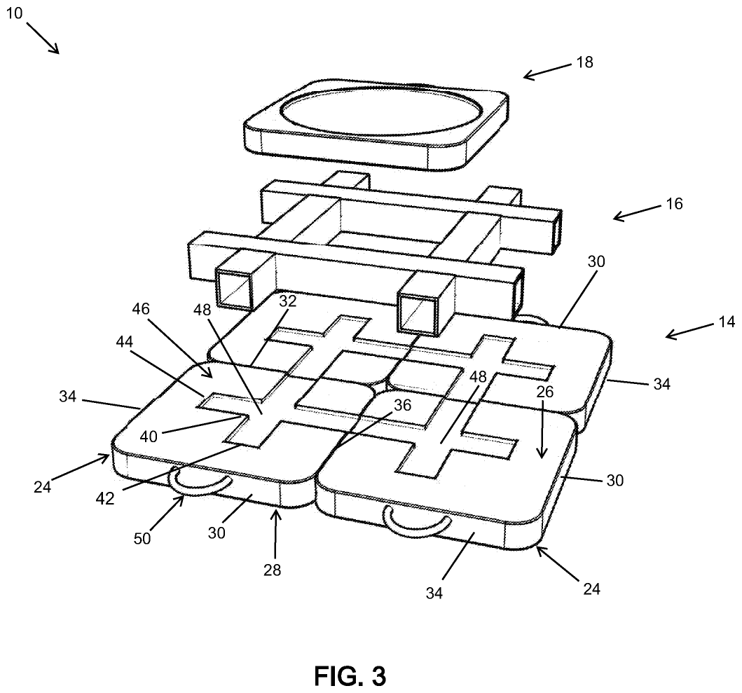

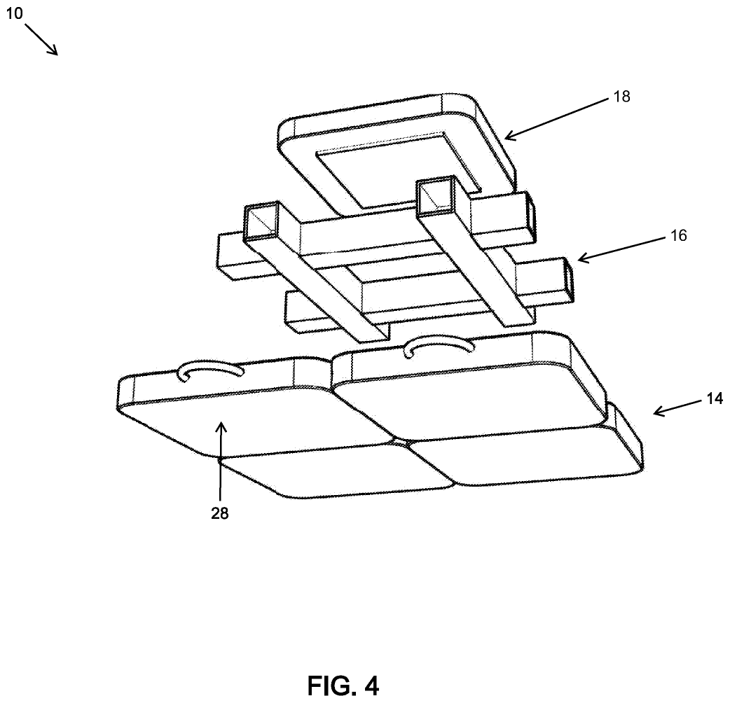

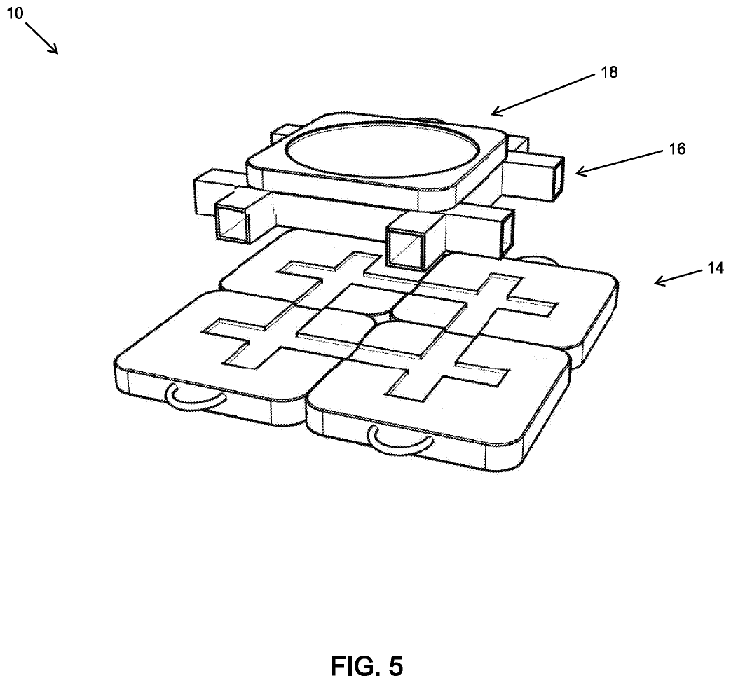

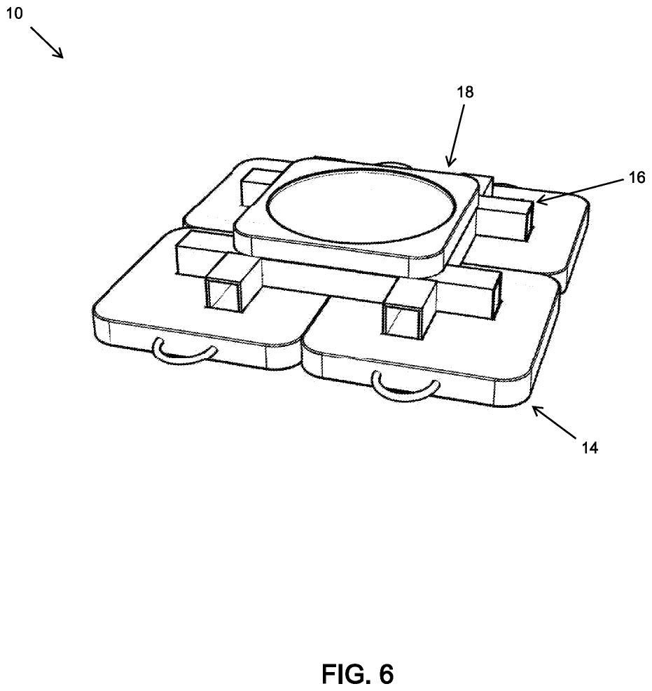

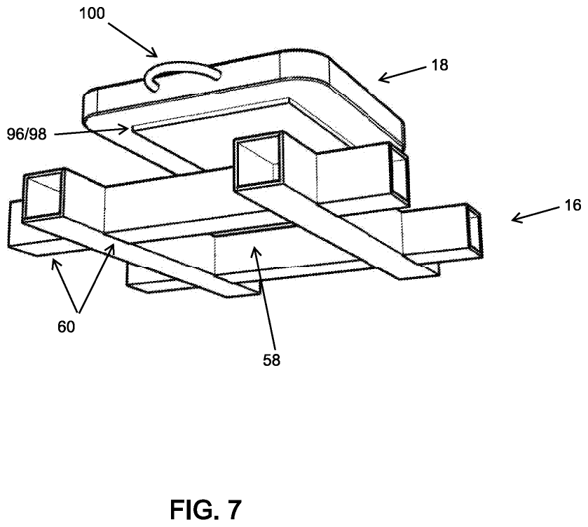

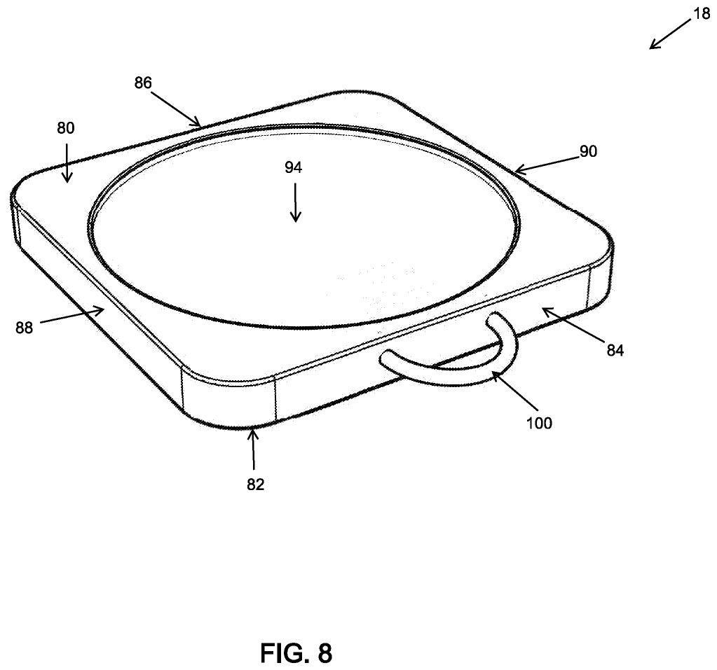

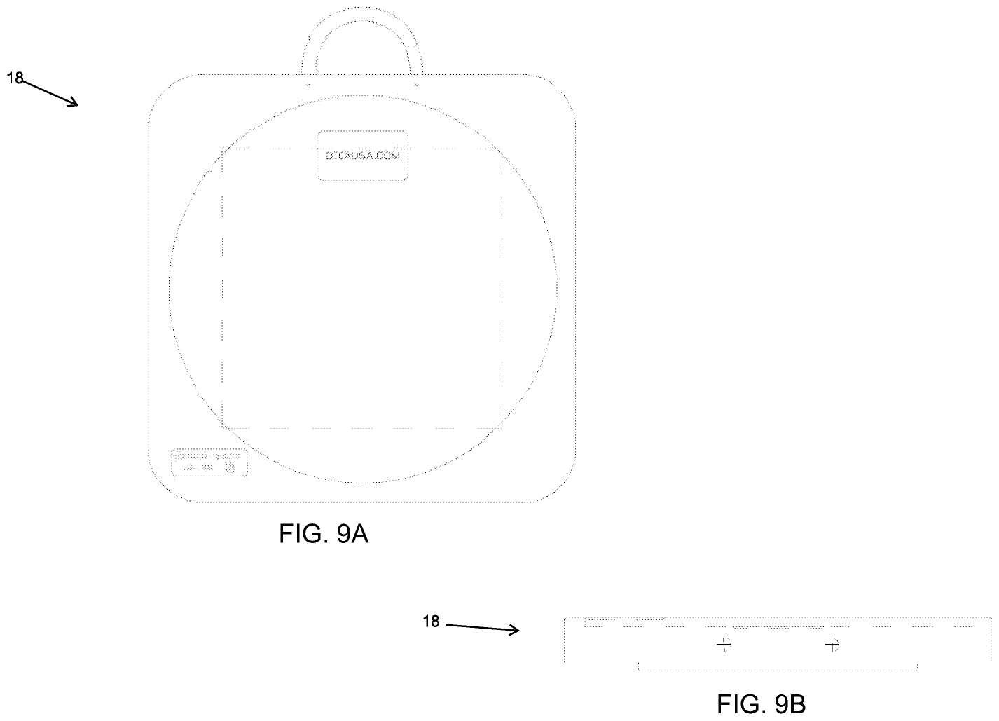

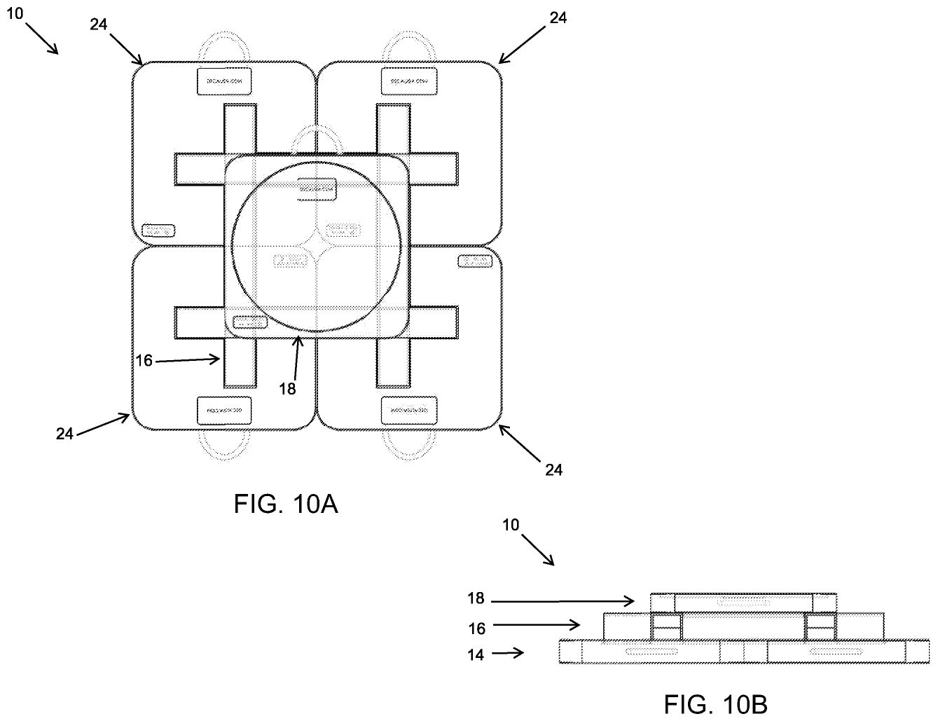

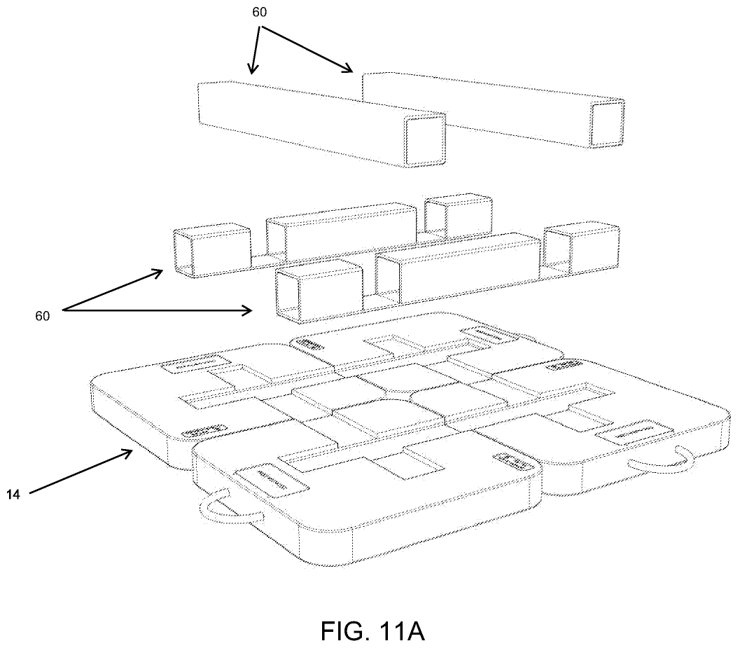

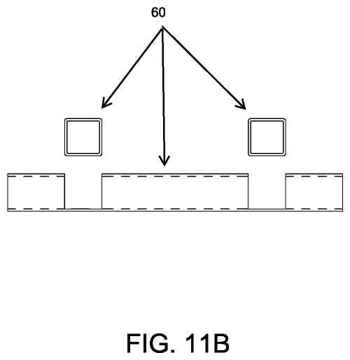

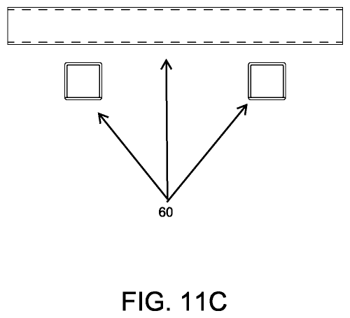

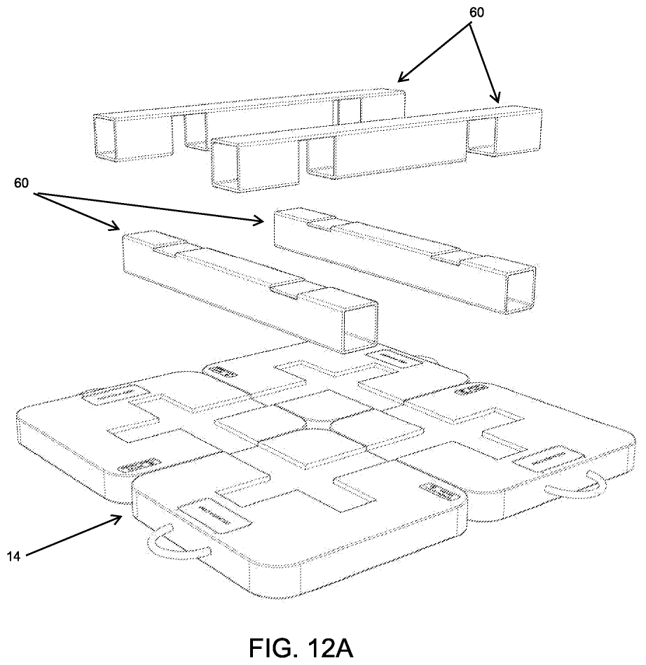

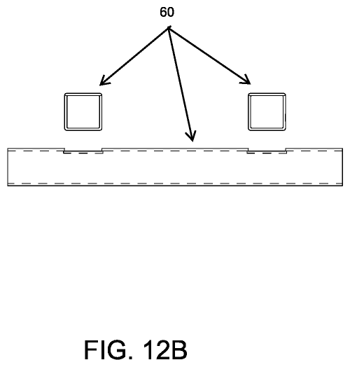

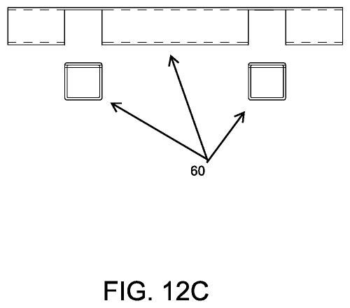

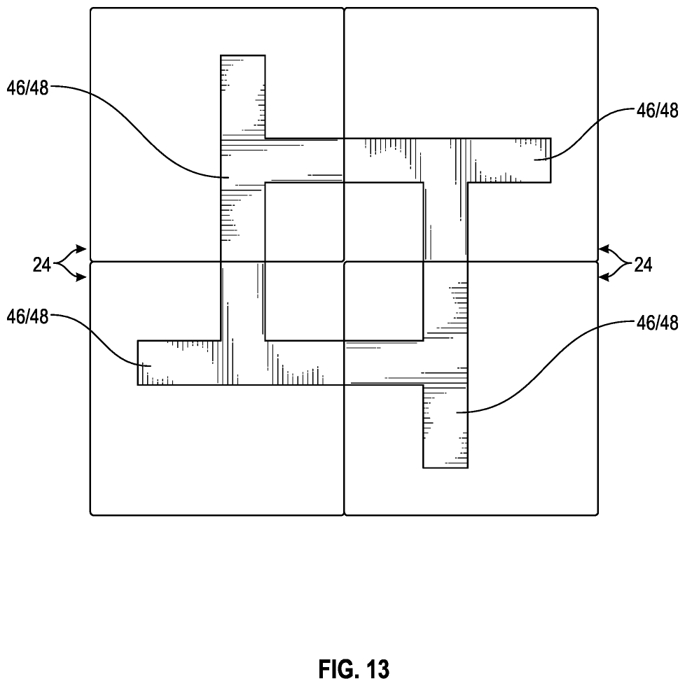

### DETAILED DESCRIPTION OF THE DISCLOSURE

In the following detailed description of the embodiments, reference is made to the accompanying drawings which form a part hereof, and in which is shown by way of illustration specific embodiments in which the invention may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures.

For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “either A or B”. As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, or sequentially, to provide looping or other series of operations aside from single operations described below. It should be presumed that any embodiment or method having features and functionality described below, in any workable combination, falls within the scope of example embodiments.

Various disclosed embodiments may be primarily described in the context of pad supports for outriggers. However, the embodiments are not so limited. It is appreciated that the embodiments may be adapted for use in other applications, which may be improved by the disclosed structures, arrangements and/or methods. The system is merely shown and described as being used in the context of pad supports for outriggers for ease of description and as one of countless examples.

### Interlocking Outrigger Pad Support System 10:

With reference to the figures, an interlocking outrigger pad support system 10 (or simply “system 10”) is presented. System 10 is formed of any suitable size, shape, and design and is configured to provide support for outriggers or feet of machinery. In the arrangement shown, as one example, system 10 includes a base pad assembly layer 14, a support layer 16, and an upper pad 18, among other components.

### Base Pad Assembly Layer 14:

Base pad assembly layer 14 is formed of any suitable size, shape, and design and is configured to provide a plurality of base pads 24 for support of support layer 16.

In the arrangement shown, as one example, base pad assembly layer 14 includes four base pads 24 configured to be placed next to one another to form a larger base support area to facilitate support of outriggers or feet of machinery by system 10.

### Base Pads 24:

Base pads 24 are formed of any suitable size, shape, and design and are configured to distribute weight of support layer 16 over their respective areas (in order to increase the surface area of engagement and to increase the surface area of weight distribution). In the arrangement shown, as one example, base pads 24 have a generally square or rectangular planer shape having an upper surface 26 and a lower surface 28 that are generally flat extending between a front edge 30, a back edge 32, a right edge 34, and a left edge 36.

In the arrangement shown, as one example, when base pads 24 are generally square or rectangular in shape, when base pads 24 are assembled in edge-to-edge alignment to form base pad assembly layer 14, the combined and assembled base pad assembly layer 14 is itself generally square or rectangular in shape. However, any other size, shape and design is hereby contemplated. As an example, each base pad 24 may have a rounded or curved outward facing edge such that the combined and assembled base pad assembly layer 14 takes on a generally round or oval shape. Alternatively, each of the base pads 24 may be formed like a like a triangular member or a slice of a circular member (e.g. pie shaped) to form an overall round or oval shape. Alternatively, the outward edge of each base pad 24 may have angles to it such that the combined and assembled base pad assembly layer 14 takes on a generally triangular, quadrilateral, pentagonal, hexagonal, heptagonal, octagonal, nonagonal, decagonal, or any other polygonal shape. Notably, base pad assembly layer 14 may take the form of a symmetric shape and/or an equilateral polygonal shape, or alternatively base pad assembly layer 14 may take on an irregular and/or non-symmetric shape. Any other shape, design or configuration is hereby contemplated for use.

Notably, while the drawings show each of the base pads 24 of base pad assembly layer 14 having edges that form a portion of the exterior peripheral edge of base pad assembly layer 14, it is hereby contemplated that base pad assembly layer 14 may be formed of a greater number of base pads 24, particularly for larger applications, and in these applications, there may be base pads 24 that are interior-only and do not have an edge that forms a part of the exterior peripheral edge of base pad assembly layer 14.

In this example arrangement, base pads 24 have alignment features 46 on upper surface 26. Alignment features 46 are formed of any suitable size, shape, or design, and are configured to facilitate alignment and interconnection of support layer 16 with base pad assembly layer 14. In the arrangement shown, as one example, alignment features 46 are recesses 48, which extend downward into upper surface 26 of the base pads 24 a distance. However, in an alternative arrangement, alignment features 46 may be protrusions, a combination of protrusions and/or recesses, and/or any other feature.

In this example arrangement shown, alignment features 46 are generally square or rectangular recesses 48 that extend a distance downward into the material of the base pads 24. In the arrangement shown, as one example, these alignment features 46 form a cross shape configured to receive and engage with two support members 60 of support layer 16 in order to provide a stable base for outriggers or feet of machinery. In this example arrangement, a first portion of the recesses 48 extends forward from back edge 32 past a center point 40 of base pads 24 to a first inner point 42 and a second portion of the recesses 48 extends rightward from left edge 36 past center point 40 of base pads 24 to a second inner point 44.

In the arrangement shown, system 10 includes four base pads 24 that are respectively oriented at 0, 90, 180, and 270 degrees when viewed from the top, and placed next to one another to align recesses 48 to receive support layer 16. In this way, when support members 60 of support layer 16 are placed on top of a base pads 24, the recesses 48 receive and engage a lower portion of the support members 60 with close and tight tolerances to hold support members 60 in a position at which downward force applied by support members 60 to base pads 24 will be evenly distributed across lower surface 28 of base pads 24. In this manner, recesses 48 operate to facilitate alignment of support layer 16 with base pad assembly layer 14 and also provide increased strength and stability. Installation in this manner helps to prevent shifting and movement of base pads 24 and/or support layer 16 during use. Or, said another way, in the arrangement shown, as one example, the lower portion of support members 60 nest within the recesses 48 of alignment features 46 of base pads 24, thereby engaging and locking support members 60 across all base pads 24. That is, in the arrangement shown, when base pads 24 are aligned in an edge-to-edge arrangement, alignment features 46 form a continuous groove or recess 48 across all base pads 24 thereby locking all base pads 24 together when support members 60 are installed therein.

Although the arrangements are primarily described with reference to base pads 24 having cross shaped recesses 48 configured to hold two support members 60 of support layer 16, the embodiments are not so limited. Rather, it is contemplated that recesses 48 may have various other shapes to accommodate connection with a support layer 16 having a greater or fewer number of support members 60 and/or having support members 60 in different arrangements. Moreover, it is contemplated that in one or more arrangements, alignment features 46 of base pads 24 may include protrusions rising up from upper surface 26 to engage and interlock with support layer 16 in lieu of or in addition to recesses 48.

### Handles 50:

In the arrangement shown, as one example, base pads 24 include handles 50 to facilitate easy transportation, setup, and disassembly of base pad assembly layer 14 of system 10. Handles 50 are formed of any suitable size, shape, and design and are configured to facilitate handheld carrying of base pads 24 of base pad assembly layer 14. In the arrangement shown, as one example, handles 50 are flexible loop type handles attached to edges of base pads 24. However, embodiments are not so limited. Rather, it is contemplated that handle 50 may be implemented using various different types of rigid or flexible handles or handgrips including but not limited to loops, posts, knobs, holes, recesses, protrusions, and/or any other type of handle or handgrip.

In this example arrangement, two base pads 24 have handles 50 attached to front edge 30 and two base pads 24 have handles 50 attached to right edge 34. However, the embodiments are not so limited. Rather, it is contemplated that in various different arrangements, handles 50 may be positioned at any location that does not interfere with the positioning and interconnection of base pads 24, support layer 16 and or components of system 10. Moreover, it is further contemplated that in some arrangements, handles 50 may be omitted.

### Support Layer 16:

Support layer 16 is formed of any suitable size, shape, and design and is configured to engage and interconnect with base pads 24 of base pad assembly layer 14 and upper pad 18 and distribute weight from upper pad 18 across base pads 24. In the arrangement shown, as one example, support layer 16 includes four support members 60 that interconnect in an overlapping arrangement having a general shape of a squared hashtag with an open center 58. However, the embodiments are not so limited. Rather, it is contemplated that support layer 16 may have greater or fewer support members 60 and/or have support members 60 arranged in different shapes or positions.

### Support Members 60:

Support members 60 are formed of any suitable size, shape, and design and are configured to interconnect to form support layer 16 and distribute weight from upper pad 18 across base pads 24. In the arrangement shown, support members 60 have an elongated square or rectangular shape having a top 62, a bottom 64, and opposing sides 66 extending between opposing ends 68, however any other shape or configuration is hereby contemplated for use. In this example arrangement, support member 60 have notches 72 proximate to ends 68 to facilitate interconnection of support members 60. In this example arrangement, two support members 60 have upward facing notches 72 extending downward into top 62 of the support members 60 and the other two support members 60 have downward facing notches 72 extending upward into bottom 64 of the support members 60. In this way, four support members 60 are aligned in a generally square and perpendicular alignment to one another. In this example arrangement, support members 60 are interconnected by positioning the support members 60 such that downward facing notches 72 are over and aligned with upward facing notches 72 in overlapping perpendicular alignment to one another. The pair of support members 60 with downward facing notches 72 are then lowered so downward facing notches 72 and upward facing notches 72 receive and interconnect with one another. However, the embodiments are not so limited. Rather it is contemplated that, in one or more arrangements, support members 60 of support layer 16 may be interconnected using various means or methods including but not limited to, for example, screwing, bolting, stapling, fasteners, riveting, bonding, adhering, welding, adhesives, interlocking, friction fitting, or any other connecting method or means.

In the arrangement shown, as one example, with support members 60 interconnected with one another to form support layer 16, support layer 16 can be positioned and held within recesses 48 of base pads 24. With support members 60 positioned within recesses 48 of base pads 24, and with all notches 72 of support members 60 interconnected, the support members 60 provide rigidity to prevent movement of base pads 24 and support members 60 while also distributing weight from upper pad 18 across base pads 24.

In the arrangement shown, as one example, downward facing notches 72 and upward facing notches 72 are generally similar in size. That is, in the arrangement shown, as one example, downward facing notches 72 extend upward a distance approximately halfway between bottom 64 and top 62 and upward facing notches 72 extend downward a distance approximately halfway between top 62 and bottom 64. However, notches 72 are not so limited. In an alternative arrangement shown, as one example, notches 72 on two support members 60 are larger than the notches 72 in the other two support members 60. In this alternative arrangement shown, as one example, upward facing notches 72 extend downward into top 62 of support member 60 a distance slightly less than the total distance between top 62 and bottom 64 of support member 60. In this alternative arrangement shown, as one example, downward facing notches 72 extend upward into bottom surface 64 a distance such that when upward facing notches 72 and downward facing notches 72 are aligned and downward facing notches 72 are pushed down on upward facing notches 72, the tops 62 of each support member 70 are generally coplanar.

In yet another alternative arrangement shown, as one example, only two support members 60 have notches 72. In this alternative arrangement, as one example, the notches 72 in two of the support members 60 are deep notches which extend a distance slightly less than the total distance between top 62 and bottom 64 of support member 60. In this arrangement the two other support members are aligned with notches 72 and lowered into notches 72. In this configuration, the tops 62 of the support members 60 without notches 72 are slightly higher than the tops 62 of support members 60 with notches 72. Also in this alternative arrangement shown, as one example, in order to account for this difference in height, the recesses 48 in base pads 24 within which the support members 60 with notches 72 rest are slightly deeper than the recesses 48 within which the support members 60 without notches 72 rest. In this way, when support members 60 are lowered into recesses 48, the bottom surface of notches 72 are coplanar with the bottom of recesses 48 and, when the support members 60 without notches 72 are lowered into notches 72, the rest on the bottom surface of notches 72 and in recesses 48 and the tops 62 of all support members 60 are coplanar in this arrangement.

In one or more arrangements, support members 60 are formed of a metallic material, such as aluminum, steel, or an alloy or any other metallic material to provide extreme ruggedness and durability. Additionally or alternatively, in one or more arrangements, support members 60 are formed of a plastic material, a rubber material, a synthetic rubber material, an acrylic material, a nylon material, a fiberglass material, a foam material, a UHMW material, a polyethylene material or any other composite material and/or non-metallic material. Additionally or alternatively, in one or more arrangements, support members 60 are formed of a combination of metallic materials or components and non-metallic materials or components.

Support members 60 may be formed of a single, unitary member that is formed in a manufacturing process such as molding, pressing, forming, additive formation, machining, extrusion, casting, or the like to form a unitary and monolithic member. Alternatively, support members 60 may be formed of multiple pieces that are connected or assembled to one another such as through screwing, bolting, stapling, fasteners, riveting, bonding, adhering, welding, adhesives, interlocking, friction fitting, or any other connecting method or means.

In the arrangement shown, support members 60 have a hollow square tube shape, which reduces weight of the metallic material while retaining rigidity of support members 60. However, the embodiments are not so limited. Rather, it is contemplated that in one or more arrangements, support members 60 may be of solid internal construction, hollow internal construction, honeycomb internal construction, or any other internal construction.

In the arrangement shown, as one example, four support members 60 are shown in a generally square or rectangular alignment to one another thereby forming a hollow open center 58 between the four support members 60. Any number of support members 60 are hereby contemplated for use. In an alternative arrangement, additional support members 60 may fill the open center 58. As one example, one, two or more additional support members 60 may extend across the open center 58 either partially filling this space or wholly filling this space.

Alternatively, an additional component, such as a block or other component may be placed within open center 58 thereby partially or wholly filling this space. Additional support members 60, or a block or other object, may serve to transfer weight from upper pad 18 to base pads 24 in the area of open center 58.

### Upper Pad 18:

Upper pad 18 is formed of any suitable size, shape, and design and is configured to provide an upper surface for support for outriggers or feet of machinery and to distribute weight of such outriggers or feet of machinery across support layer 16 and then across base pads 24.

In the arrangement shown, as one example, upper pad 18 has a generally square or rectangular planer shape having an upper surface 80 and a lower surface 82 extending between a front edge 84, a back edge 86, a right edge 88, and a left edge 90. In this example arrangement, upper pad 18 has a recess 94 formed in upper surface 80. In this example arrangement, recess 94 has a generally circular shape and is configured to receive and hold outriggers or feet of machinery within recess 94 to prevent shifting of such outriggers or feet during use. Any other shape of this recess 94 such as square, rectangular or any other shape is hereby contemplated. However, the embodiments are not so limited. Rather, it is contemplated that, in one or more arrangements, upper pad 18 may have protrusions rising up from upper surface 80 (or another type of connection feature) to engage, hold and/or lock or align outriggers or feet of machinery in addition to or in lieu of recess 94.

In this example arrangement, upper pad 18 has an alignment feature 96 on lower surface 82. Alignment feature 96 is formed of any suitable size, shape, or design, and is configured to facilitate alignment and interconnection of upper pad 18 with support layer 16.

The purpose of the alignment feature 96 is to align upper pad 18 with the top 62 of support members 60. As such, all teaching and disclosure related to alignment feature 46 in the upper surface 26 of base pads 24 is applicable and repeated with respect to alignment feature 96 in the lower surface 82 of upper pad 18, unless stated otherwise. That is, alignment feature 96 may be a protrusion, a recess, a plurality of protrusions, a plurality of recesses and/or a combination of protrusions and recesses or any other feature that aligns, engages, locks and/or holds upper pad 18 with support members 60.

In the arrangement shown, as one example, alignment features 96 includes a protrusion 98 extending downward from lower surface 82. Protrusion 98 is formed of any suitable size, shape, and design and is configured to engage and interlock with support members 60 of support layer 16 in order to prevent upper pad 18 from shifting relative to support layer 16 in order to provide a stable base for outriggers or feet of machinery. In this example arrangement, protrusion 98 has a generally square shape configured to be received within the generally square or rectangular open center 58 of support layer 16 between the four perpendicularly crossed support members 60. However, the embodiments are not so limited. Rather, it is contemplated that protrusion 98 may have various other shapes to accommodate connection with a support layer 16 having a greater or fewer number of support members 60 and/or having support members 60 in different arrangements. Moreover, it is contemplated that in one or more arrangements, alignment feature 96 of upper pad 18 may include recesses in lower surface 82 to engage and interlock with support layer 16 in a similar manner to recesses 48 of base pads 24 in addition to or in lieu of protrusion 98.

In an alternative arrangement, alignment feature 96 is a generally square or rectangular recess or recesses that extend a distance into the material of the upper pad 18. In the alternative arrangement, as one example, alignment feature 96 has a cross shape configured to receive and engage with the tops 62 of support members 60 of support layer 16 in order to provide a stable base for outriggers or feet of machinery. In this way, when upper pad 18 is placed on tops 62 of support members 60, the recesses of alignment feature 96 receive and engage the tops 62 of the support members 60 with close and tight tolerances to hold support members 60 in a position at which downward force applied by upper pad 18 to support members 60 will be evenly distributed across base pads 24. In this manner, recesses of alignment feature 96 operate to facilitate alignment of support layer 16 with upper pad 18 and also provide increased strength and stability. Installation in this manner helps to prevent shifting and movement of upper pad 18 and/or support layer 16 during use. Or, said another way, in the alternative arrangement, as one example, the tops 62 of support members 60 nest within the recesses of alignment feature 96 of base pad 18, thereby engaging and locking support members 60 and upper pad 18. That is, in the alternative arrangement, with upper pad 18 having a groove or recesses in its lower surface 82 that engage the tops 62 of support members 60, the alignment feature 96 engages and locks all support members 60 together when upper pad 18 is installed thereon.

This configuration of upper pad 18 having recesses as alignment feature 96 helps facilitate alignment of upper pad 18 to support members 60 particularly when additional support members 60 extend across open center 58. In this arrangement, the recesses are configured to receive the tops 62 of the additional support members 60 in open center 58.

### Handle 100:

In the arrangement shown, as one example, upper pad 18 include a handle 100 to facilitate easy transportation, setup, and disassembly of system 10. Handle 100 is formed of any suitable size, shape, and design and is configured to facilitate handheld carrying of upper pad 18. As described with reference to handle 50 of base pads 24, in the arrangement shown, handle 100 is a flexible loop type handle attached to an edge of upper pad 18. However, embodiments are not so limited. Rather, it is contemplated that handle 100 may be implemented using various different types of rigid or flexible handles or handgrips including but not limited to loops, posts, knobs, holes, recesses, protrusions, and/or any other type of handle or handgrip.

In this example arrangement, handle 100 is attached to front edge 84 of upper pad 18. However, the embodiments are not so limited. Rather, it is contemplated that in various different arrangements, handle 100 may be positioned at any location that does not interfere with the positioning and interconnection of upper pad 18 with support layer 16 and or components of system 10. Moreover, it is further contemplated that in some arrangements, handle 100 may be omitted.

### Materials for Base Pads 24 and Upper Pad 18:

In various different arrangements, base pads 24 of base pad assembly layer 14 and upper pad 18 may be formed of various different materials including but not limited to, for example, metallic materials, such as aluminum, steel, or an alloy or any other metallic material, or non-metallic materials, such as a plastic material, a rubber material, a synthetic rubber material, an acrylic material, a nylon material, a fiberglass material, a foam material, a UHMW material, a polyethylene material or any other composite material and/or non-metallic material, as well as any combination of such materials.

In one or more arrangements, upper pad 18 and/or base pads 24 are formed of a compressible material to promote secure connection of system 10 with a ground or floor surface and with outriggers or feet of machinery supported thereon. In some various arrangements, such compressible material may include but is not limited to, for example, a rubber, a synthetic rubber, a rubber composite, a silicone, a plastic, a foam, a polyethylene material or any other composite material, non-metallic material, or any other compressible material, flexible material or any combination thereof. In one arrangement, upper pad 18 and base pads 24 are formed of a material that has a high coefficient of friction so as to ensure the system 10 securely engages the ground or floor surface and the outriggers or feet of the machinery supported by the system 10 such that they securely engage one another and provide a sure-footing thereby preventing slipping and other relative movement.

In one or more arrangements, upper pad 18 and base pads 24 are formed partially of or primarily of ground up recycled tires for vehicles. This ground up recycled tire material is then added to a mold and formed into upper pad 18 and base pads 24 with the addition of pressure and heat in a recipe which may include additional additives such as virgin material additives, strengthening additives such as fiberglass strands, strings, chords, netting or other structural supports, binders, or any other materials. In one or more arrangements structural reinforcement may be added to upper pad 18 and base pads 24 to increase the structural rigidity and strength of upper pad 18 and base pads 24 such as steel or iron rods, netting, bars, frame members or any other shaped member. In one or more arrangements, such structural reinforcement is incorporated into the material during the manufacturing process and therefore are completely embedded within upper pad 18 and base pads 24.

### In Operation:

In the arrangement shown, as one example, system 10 is formed of interlocking components that can be disassembled to facilitate easy storage and transportation while providing stable support and distribution of weight across a larger area for support of outriggers or feet of machinery. In one or more arrangements, as one example, base pads 24 of base pad assembly layer 14 and upper pad 18 have dimensions of a square measuring approximately 2 ft×2 ft and support members 60 of support layer 16 are approximately 3 ft long. These dimensions allow system 10 to be disassembled and easily transported to a worksite in the bed of a truck or even within the cab. In this example arrangement, base pads 24 upper pad 18 may also be stacked to facilitate compact and organized storage of system 10 when not in use. When system 10 is assembled, the base pads 24 of base pad assembly layer 14 distribute weight across approximately 16 ft². However, the embodiments are not so limited. Rather, it is contemplated that components of system 10 may be scaled up or down to any desired size.

To assemble system 10, base pads 24 are first placed next to one another on a floor or on the ground at a worksite to form base pad assembly layer 14. More specifically, in this example arrangement, base pads 24 are placed next to one another to form a square, with base pads 24 oriented at 0, 90, 180, and 270 degrees so the combined recesses 48 form a cross shape or the shape of a squared hashtag.

With base pads 24 placed to form base pad assembly layer 14, a first pair of support members 60 are placed in recesses 48 parallel to one another with notches 72 facing upward. A second pair of the support members 60 are aligned with recesses 48 in positions parallel to one another and perpendicular to the first pair of support members 60 with notches 72 facing downward. In these positions, the second pair of the support members 60 are lowered into the recesses 48. At the same time, downward facing notches 72 and upward facing notches 72 receive and interconnect with one another to form support layer 16.

With support members 60 placed to form support layer 16, upper pad 18 is placed on the tops 62 of support members 60 with protrusion 98 aligned with and extending into open center 58 of support layer 16 to complete assembly of system 10. With components of system 10 in these positions, the components are interconnected and are further secured in place when weight is applied to the upper surface 80 of upper pad 18. In this manner, an interconnected outrigger pad support system 10 is formed that can distribute loads over a larger area, while retaining the ability to be disassembled for easy transportation and/or storage.

### Alternative Arrangement:

While system 10 has been disclosed according to the arrangement shown, as one example, system 10 is not so limited. An alternative arrangement of system 10 is presented. In the alternative arrangement, system 10 and its components are the same as previously described, with the exception of the details provided hereafter. In this alternative arrangement, as one example, support members 60 do not interlock, rather they rest adjacent each other within recesses 48 of base pads 24.

In the alternative arrangement shown, as one example, base pads 24 of base pad assembly layer 14 includes alignment features 46 which are recesses 48. In this arrangement, recesses 48 do not form a cross shape, rather the recesses 48 extend such that one end is adjacent an edge of another recess 48. In this alternative arrangement shown, as one example, a first portion of the recesses 48 extends forward from a back edge 32 toward a center point 40 until it meets an edge of a second portion of the recesses 48. In this alternative arrangement, as one example, the second portion of recesses 48 extends forward from left edge 36 past center point 40 of base pads 24 to a second inner point 44. In this way, the first portion and second portion of recesses 48 do not cross, rather the first portion just meets and rests adjacent to the second portion of recesses 48.

In this alternative arrangement shown, as one example, support members 60 of support layer 16 do not interlock, rather they rest in recesses 48 directly adjacent other support members 60. That is, a single support member 60 is placed within each recess 48 and, when all support members 60 are within each recess 48, each support member 60 has another support member 60 adjacent one end 68 of the support member 60.

From the above discussion it will be appreciated that the disclosed system presented herein improves upon the state of the art. Specifically, in one or more arrangements, an improved outrigger pad support system is provided: that has the necessary strength, rigidity, and durability, while also remaining affordable and relatively lightweight; that is formed of interlocking components; that is convenient to transport and store; that can effectively distribute load over a larger area; that is rigid; that minimizes displacement under heavy loads; that is relatively easy to manufacture; that is easy to use; that is relatively lightweight; that is easy to move; has a robust design; that is durable; that has a long useful life; that is not easily susceptible to wear and tear; that is high quality; that is relatively inexpensive; that increases safety for the operator and other individuals and property in the area; that is easy to transport; that effectively distributes loads & pressures from outriggers to levels the supporting surface can withstand, or levels deemed acceptable by site owners; that protects supporting surfaces from damage caused by outriggers; and/or that has the strength to withstand heavy loads, among countless other advantages and improvements.

It will be appreciated by those skilled in the art that other various modifications could be made to the embodiments without parting from the spirit and scope of this disclosure. All such modifications and changes fall within the scope of the claims and are intended to be covered thereby.

What is claimed:

1. An outrigger pad support system, comprising:
a base pad assembly layer;
the base pad assembly layer formed of a plurality of base pads;
wherein each of the plurality of base pads have an upper surface and a lower surface;
the base pads of the base pad assembly layer having alignment features that extend across at least a portion of the upper surface of the plurality of base pads;
a support layer;
an upper pad;
the upper pad having an upper surface and a lower surface;
the lower surface of the upper pad having alignment features;
wherein when the support layer is placed on top of the base pad assembly layer the support layer engages and is held in place by the alignment features of the base pads of the base pad assembly layer;
wherein when the upper pad is placed on top of the support layer the alignment features of the upper pad engage the support layer and the upper pad is held in place by the support layer.

2. The system of claim 1, wherein the plurality of base pads includes four base pads.

3. The system of claim 1, wherein the plurality of base pads are positioned in edge-to-edge engagement with one another to form the base pad assembly layer.

4. The system of claim 1, wherein the plurality of base pads are formed of generally square or rectangular pads.

5. The system of claim 1, wherein the plurality of base pads form a generally square or rectangular member when they are assembled to form the base pad assembly layer.

6. The system of claim 1, wherein the plurality of base pads form a generally round, oval, pentagonal, hexagonal, heptagonal or octagonal member when they are assembled to form the base pad assembly layer.

7. The system of claim 1, wherein the upper surface of each of the plurality of base pads includes one of the alignment features.

8. The system of claim 1, wherein the alignment features in the upper surfaces of the plurality of base pads are recesses.

9. The system of claim 1, wherein the alignment features in the upper surfaces of the plurality of base pads are protrusions.

10. The system of claim 1, wherein the alignment feature in the lower surface of the upper pad is a protrusion that fits within an open center portion of the support layer.

11. The system of claim 1, wherein the alignment feature in the lower surface of the upper pad is a recess that receives a portion of the support layer.

12. The system of claim 1, wherein each of the plurality of base pads includes a handle that extends outward from an edge of the respective base pad.

13. The system of claim 1, wherein the support layer is formed of a plurality of metallic support members.

14. The system of claim 1, wherein the support layer is formed of a plurality of hollow tubes.

15. The system of claim 1, wherein the support layer is formed of a plurality of rigid beams.

16. The system of claim 1, wherein the support layer is formed of a first pair of metallic support members positioned in generally parallel spaced alignment to one another and a second pair of metallic support members positioned in generally parallel spaced alignment to one another; wherein the first pair of metallic support members are positioned in generally perpendicular alignment to the second pair of metallic support members.

17. The system of claim 1, wherein the support layer is formed of two pairs of support members that engage each other in generally perpendicular alignment to one another.

18. The system of claim 1, wherein the support layer is formed of a plurality of support members and wherein at least some of the plurality of support members have notches and wherein the notches facilitate engagement of the plurality of structural support members with one another.

19. The system of claim 1, wherein an upper surface of the upper pad includes a recess configured to receive a foot of an outrigger.

20. The system of claim 1, wherein an upper surface of the upper pad includes side walls, configured to prevent a foot of an outrigger from slipping off the upper pad.

21. The system of claim 1, wherein the support layer spreads pressure across the plurality of base pads.

22. An outrigger pad support system, comprising:
a base pad assembly layer;
the base pad assembly layer formed of a plurality of base pads;
the plurality of base pads having an upper surface
the plurality of base pads of the base pad assembly layer having alignment features that extend across the upper surface of the plurality of base pads;
a support layer;
the support layer formed of a plurality of support members;
wherein the plurality of support members engage one another;
an upper pad layer;
the upper pad layer having an alignment feature in a lower surface;
wherein the support layer engages and is held by the alignment feature in the upper surface of the plurality of base pads;
wherein when the upper pad is placed on top of the support layer the alignment features of the upper pad engage the support layer and the upper pad is held in place by the support layer.

23. The system of claim 22, wherein the plurality of base pads includes four base pads.

24. The system of claim 22, wherein the plurality of base pads are positioned in edge-to-edge engagement with one another to form the base pad assembly layer.

25. The system of claim 22, wherein the plurality of base pads are formed of generally square or rectangular pads.

26. The system of claim 22, wherein the plurality of base pads form a generally square or rectangular member when they are assembled to form the base pad assembly layer.

27. The system of claim 22, wherein the upper surface of each of the plurality of base pads includes one of the alignment features of the plurality of base pads.

28. The system of claim 22, wherein the alignment features in the upper surface of the plurality of base pads are recesses.

29. The system of claim 22, wherein the alignment features in the upper surface of the plurality of base pads are protrusions.

30. The system of claim 22, wherein the alignment feature in the lower surface of the upper pad is a protrusion that fits within a portion of the support layer.

31. The system of claim 22, wherein the alignment feature in the lower surface of the upper pad is a recess that receives a portion of the support layer.

32. The system of claim 22, wherein each of the plurality of base pads includes a handle that extends outward from an edge of the respective base pad.

33. The system of claim 22, wherein the support layer is formed of a plurality of metallic support members.

34. The system of claim 22, wherein the support layer is formed of a plurality of hollow tubes.

35. The system of claim 22, wherein the support layer is formed of a plurality of rigid beams.

36. The system of claim 22, wherein the support layer is formed of a first pair of metallic support members positioned in generally parallel spaced alignment to one another and a second pair of metallic support members positioned in generally parallel spaced alignment to one another; wherein the first pair of metallic support members are positioned in generally perpendicular alignment to the second pair of metallic support members.

37. The system of claim 22, wherein the plurality of support members include two pairs of support members that engage in generally perpendicular alignment to one another.

38. The system of claim 22, wherein the plurality of support members have notches that facilitate the engagement of the plurality of support members.

39. The system of claim 22, wherein an upper surface of the upper pad layer includes a recess, wherein the recess is configured to receive a foot of an outrigger.

40. The system of claim 22, wherein an upper surface of the upper pad includes side walls, wherein the side walls are configured to prevent a foot of an outrigger from slipping off the upper pad.

41. The system of claim 22, wherein the support layer spreads pressure across the plurality of base pads.

42. An outrigger pad support system, comprising:
a base pad assembly layer;
the base pad assembly layer is formed of at least one base pad;
wherein each of the at least one base pads have an upper surface and a lower surface;
wherein each of the at least one base pads of the base pad assembly layer have alignment features that extends across at least a portion of the upper surface of the at least one base pad;
a support layer;
an upper pad;
the upper pad having an upper surface and a lower surface;
the lower surface of the upper pad having alignment features;
wherein when the support layer is placed on top of the base pad assembly layer, the support layer engages and is held in place by the alignment features of the at least one base pad of the base pad assembly layer;
wherein when the upper pad is placed on top of the support layer the alignment features of the upper pad engages and is held in place by the support layer.

43. The system of claim 42, wherein the base pad assembly layer forms a generally square or rectangular shape when assembled and when viewed from above.

44. The system of claim 42, wherein the base pad assembly layer forms a generally round, oval, pentagonal, hexagonal, heptagonal or octagonal shape when assembled and when viewed from above.
